(19) United States
(12) Patent Application Publication
(10) Pub. No.: US 2019/0070822 A1
(43) Pub. Date: Mar. 7, 2019

(54) Products Made from Paper, Polyethylene or other Materials with Digitally Printed Images

(71) Applicants: Steve Kohn, Short Hills, NJ (US); Luis DeOliveira, Lanoka Harbor, NJ (US)

(72) Inventors: Steve Kohn, Short Hills, NJ (US); Luis DeOliveira, Lanoka Harbor, NJ (US)

(21) Appl. No.: 15/698,987

(22) Filed: Sep. 8, 2017

Related U.S. Application Data
(60) Provisional application No. 62/553,894, filed on Sep. 3, 2017.

(51) Int. Cl. B31B 70/88; B65D 33/00

(52) U.S. Cl. CPC B31B 70/88; B65D 35/08; B65D 33/004

(57) ABSTRACT

Products made from paper, polyethylene, or other materials with printing from a digital-based image directly onto its surface.

### RELATED APPLICATIONS

This application claims priority to provisional application Ser. No. 62/553,894 dated Sep. 3, 2017.

### FIELD OF THE INVENTION

The present invention relates to products made from paper, polyethylene, or other materials with printing from a digital-based image directly onto its surface.

### BACKGROUND OF THE INVENTION

Printed and unprinted flexible and semi-rigid packaging materials are commonly used for packing retail, industrial, and commercial products into plastic bags, paper bags, sacks, pouches, wrappers, and the like. Printed and unprinted flexible and semi-rigid packaging materials are also commonly used for covering or storing retail, industrial, and commercial products. Desired features of packaging materials include printability and different levels of opacity. Packaging materials can either be printed or unprinted. Printed packaging materials can use a single color or multiple colors. Graphics printed on the packaging materials can include company logos, association logos, advertising and text. Graphics can be used to communicate promotional or educational messages.

Offset printing is a commonly used printing technique for printing images, graphics and/or text on printed surfaces such as paper bags. Offset printing occurs when an inked area is transferred from a metal or rubber plate to a rubber cylinder (commonly called a “blanket”), and then transferred to a printing surface such as paper. The process is called “offset” because the inked image is offset or transferred to something else first (e.g. the rubber blanket) before being transferred directly to the printed surface.

Offset commercial printing presses and inkjet desktop printers both use some combination of the following ink colors: cyan (“C”), magenta (“M”), yellow (“Y”), and black (“K”). Offset printing is also typically referred to as 4-color printing or 4-color process lithography.

With offset printing, separate plates are created for each color. The plates are then put onto a press. The press pulls in the ink from ink reservoirs and puts the ink onto the plate. The press then applies pressure to the plate and the ink imprints the image from the plate onto a rubber blanket. The image is then pressed onto the paper off the blanket to make a print. Often, the ink also permeates the substrate being printed on, resulting in “bleed through” and an unacceptable end product. Offset printing occurs very rapidly and is best suited for long runs over a long period of time and for producing many items with the same printed image.

Digital printing refers to methods of printing from a digital-based image onto a surface or substrate, without requiring the need for separate, analog plates. Unlike conventional ink used in offset printing, the ink or toner used in digital printing does not permeate the substrate, but forms a thin layer on the surface. Digital printing allows for on demand printing, short turnaround time, and simple modifications of the image used for each impression (variable image printing).

U.S. Pat. No. 5,795,280 relates to an apparatus for facilitating the registration of printed matter during the manufacture of bags on fixed-size bag formation equipment, from a continuous web of a substantially non-stretchable material. Printed matter, printed upon the continuous web at regularly-spaced intervals, includes a plurality of periodically spaced reference markers.

U.S. Pat. No. 8,840,240 relates to a paper conveyance device for a printing device that includes a detector and conveyance mechanisms. The device includes a print head and feed and pressure rollers.

U.S. Pat. No. 8,857,978 relates to a paper conveyance device for a printing device that print information using a printhead on conveyed continuous paper including a paper conveyance mechanism that holds and conveys the continuous paper to the print area of the printhead, and a guide unit that has two guide surfaces facing the conveyed continuous paper.

U.S. Pat. No. 8,899,740 relates to a print medium conveyance device having a tractor, conveyance roller, and clutch mechanism. The tractor engages engagement holes formed in a line in the medium and conveys the print medium in a specific direction. The print medium can be conveyed with high precision.

U.S. patent publication no. 20030173716 relates to a colored polyolefin film printed by digital printing. The colored polyolefin film is formed by blending a coloring agent with a polyolefin, and forming a film from the blend by an extrusion process. Digital signals are supplied to a printer adapted to respond to such signals to print the colored film. Indicia may be placed on the surface of the colored film by electrostatic printing, thermal transfer printing or ink jet printing, especially with UV curable ink jet ink. The colored polyolefin film may be a multi-layer film having an opaque, cavitated core layer and at least one colored skin or tie layer.

U.S. patent publication no. 20050115200 relates to a package paper thermal printer of a tablet packing machine for printing information about prescription medicines on package paper by a thermal printhead and a ribbon tape. The thermal print head and ribbon tape are raised together so as to closely attach the ribbon tape to a lower surface of the package paper passing under the contact roller, so that information inputted into the thermal print head is transferred to the package paper by heat and characters are printed on the package paper when the actuating plate is raised.

U.S. patent publication no. 20020191036 relates to an ink jet printer for digital textile printing which uses a flat table instead of a conventional roll. An ink jet printer has a transporter part to transport an object to be printed through a path and printing part to perform the digital printing by jetting ink drops to the object. The transporting part comprises a transporting table on which the object is fixed and transported, a transporting means for transporting the table to the printing part, and a driving means for operating the transporting means.

U.S. patent publication no. 20080118746 relates to a low-cost method of coating low density polyethylene, linear low density polyethylene or combinations. The method includes treating the polyethylene with a coating and then digitally printing the coated polyethylene substrate. The coated substrate may then be overcoated to protect the printing and the substrate may then be formed. The substrate may form a small tote bag.

U.S. patent publication no. 20130324386 relates to a bag making machine with a feeder to unwind and feed a sheet in a first direction, a forming device to bend and fold the sheet to form a tubular body, a speed controller for controlling upstream and downstream speeds of advancement of the tubular body, a cutter to cut the tubular body into a plurality of tubular pieces, a direction changing device to change direction of advancement of the tubular pieces, a sewing device to close bottom side of each tubular piece and sealing device. A printing device includes a printer near the feeder to print a pattern on the surface of the fabric sheet.

U.S. patent publication no. 2011/0079531 relates to a packaging film with at least one section comprising a single or multi-layered substrate, a printed functional layer formed from a printable material forming at least in sections an outer layer of the packaging film section. The invention concerns a packaging and a packaging product unit.

U.S. patent publication no. 2015/0199786 relates to a bag that includes a flexible web in the shape of a bag and a communication member or other advertising media attached to the flexible web with an adhesive. An advertising medium includes a packaging material made of a first material and a communication member applied to the packaging material.

### SUMMARY OF THE INVENTION

The present invention relates to flexible and semi-rigid packaging materials with digitally printed graphics and/or text on the surface of the materials. It is an object of the present invention that the flexible and semi-rigid packaging materials comprise paper. It is an object of the present invention that the flexible and semi-rigid packaging materials comprise polyethylene. It is an object of the present invention that the paper flexible and semi-rigid packaging materials comprise single or multiple color graphics and text printed on the surface. It is an object of the present invention that the paper flexible and semi-rigid packaging materials comprise single or multiple color graphics or text printed on the surface. It is an object of the present invention that the polyethylene flexible and semi-rigid packaging materials comprise single or multiple color graphics and text printed on the surface. It is an object of the present invention that the polyethylene flexible and semi-rigid packaging materials comprise single or multiple color graphics or text printed on the surface.

It is an object of the present invention that the paper flexible and semi-rigid packaging materials comprise rolls of bags, bags, sheets of corrugate, corrugate, sheets of cardboard, cardboard and cartons. It is an object of the present invention that the polyethylene flexible and semi-rigid packaging materials comprise polyethylene film, sheets, tubing, bags, plastic t-sacks, sheeting, tubing, covers such as furniture covers and dust covers, and storage bags such as mattress bags and food pouches.

It is an object of the present invention that the graphics and text on the flexible and semi-rigid packaging materials comprise ink or toner. It is an object of the present invention that the graphics or text on the flexible and semi-rigid packaging materials comprise ink or toner. It is an object of the present invention that the ink or toner is adhered to the flexible and semi-rigid packaging materials by a fuser fluid. It is an object of the present invention that the ink or toner is adhered to the flexible and semi-rigid packaging materials by heat. It is an object of the present invention that the ink or toner is adhered to the flexible and semi-rigid packaging materials by UV curing. It is an object of the present invention that the ink or toner is adhered to the flexible and semi-rigid packaging materials by fuser fluid, heat, UV curing, or any combination. It is an object of the present invention that the paper flexible and semi-rigid packaging materials have digital printing on them before being formed into paper products. It is an object of the present invention that the polyethylene flexible and semi-rigid packaging materials have digital printing on them before being formed into polyethylene products. It is an object of the present invention that the paper flexible and semi-rigid packaging materials have digital printing on them after being formed into paper products. It is an object of the present invention that the polyethylene flexible and semi-rigid packaging materials have digital printing on them after being formed into polyethylene products.

The present invention relates to pinch bottom bags and flat bottom bags with digital printing of graphics and/or text on the surface of the bags. A pinch bottom bag comprises a tubular envelope closed at one end by a single glued flap. A flat bottom bag comprises a tubular envelope closed at one end by glued flaps that form a bottom. It is an object of the present invention that the pinch bottom bags and flat bottom bags comprise paper. It is an object of the present invention that the pinch bottom bags and flat bottom bags comprise polyethylene. It is an object of the present invention that the pinch bottom bags and flat bottom bags comprise single or multiple color graphics and text printed on the surface. It is an object of the present invention that the pinch bottom bags and flat bottom bags comprise single or multiple color graphics or text printed on the surface. It is an object of the present invention that the graphics and text on the pinch bottom bags and flat bottom bags comprise ink or toner. It is an object of the present invention that the graphics or text on the pinch bottom bags and flat bottom bags comprise ink or toner. It is an object of the present invention that the ink or toner is adhered to the pinch bottom bags and flat bottom bags by a fuser fluid. It is an object of the present invention that the ink or toner is adhered to the pinch bottom bags and flat bottom bags by heat. It is an object of the present invention that the ink or toner is adhered to the pinch bottom bags and flat bottom bags by UV curing. It is an object of the present invention that the ink or toner is adhered to the pinch bottom bags and flat bottom bags by fuser fluid, heat, UV curing, or any combination. It is an object of the present invention that the paper materials for paper pinch bottom bags and flat bottom bags have digital printing on them before being formed into paper pinch bottom bags and flat bottom bags. It is an object of the present invention that the polyethylene materials for making pinch bottom bags and flat bottom bags have digital printing on them before being formed into polyethylene pinch bottom bags and flat bottom bags. It is an object of the present invention that the paper materials for paper pinch bottom bags and flat bottom bags have digital printing on them after being formed into paper pinch bottom bags and flat bottom bags. It is an object of the present invention that the polyethylene materials for making pinch bottom bags and flat bottom bags have digital printing on them after being formed into polyethylene pinch bottom bags and flat bottom bags.

The present invention relates to sheets or rolls of polyethylene film used to make products with digitally printed graphics and/or text on them. It is an object of the present invention that the products comprise bags, t-sacks, and pouches. It is an object of the present invention that the graphics and text on the polyethylene film used to make products comprise ink or toner. It is an object of the present invention that the graphics or text on the polyethylene film used to make products comprise ink or toner. It is an object of the present invention that the ink or toner is adhered to the polyethylene film by a fuser fluid. It is an object of the present invention that the ink or toner is adhered to the polyethylene film by heat. It is an object of the present invention that the ink or toner is adhered to the polyethylene film by UV curing. It is an object of the present invention that the ink or toner is adhered to the polyethylene film by fuser fluid, heat, UV curing, or any combination.

### BRIEF DESCRIPTION OF DRAWINGS

FIG. 1 is a roll of paper or polyethylene with digitally printed graphics on it.

FIG. 2 are flexible packaging products without digital printing on them.

FIG. 3 are flexible packaging products with digital printing on them.

### DETAILED DESCRIPTION OF THE DRAWINGS

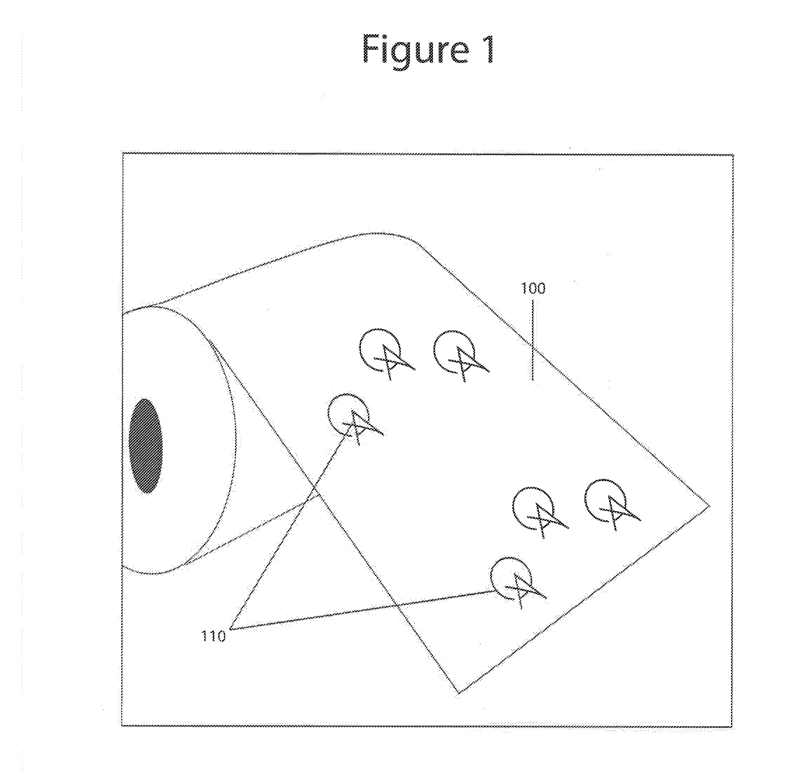

FIG. 1 shows a roll of paper or polyethylene 100 with digitally printed graphics 120 on it prior to being formed into packaging products. The digitally printed graphics 120 are repeated on the roll 100 so that when the paper or polyethylene is formed into packaging products, the graphics are in the same location on every packaging product produced

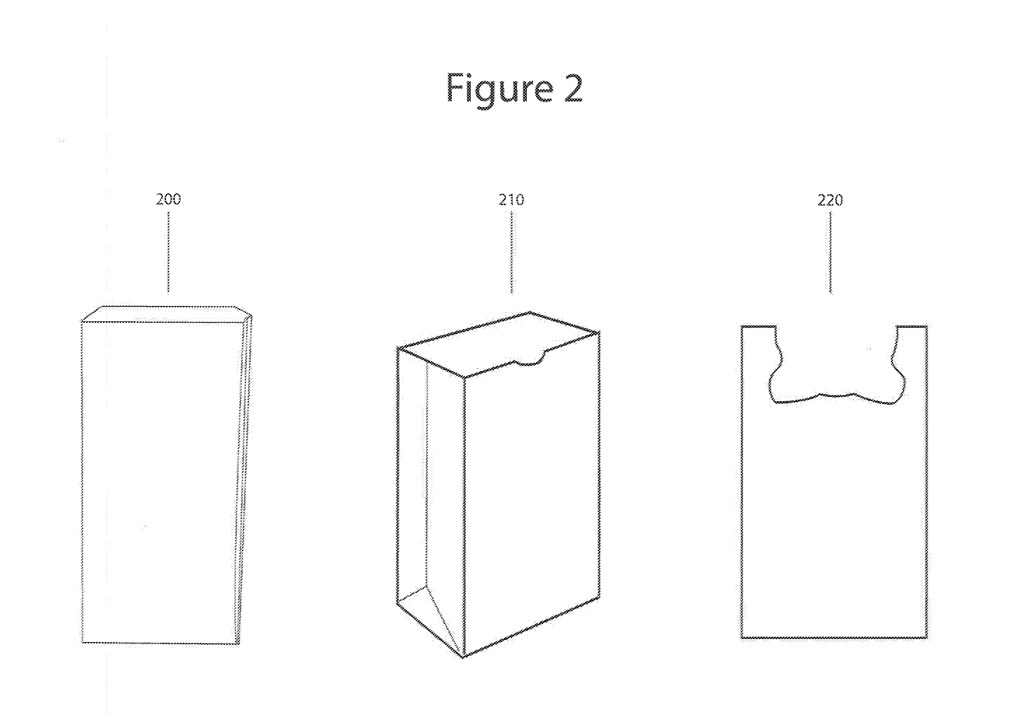

FIG. 2 shows pinch bottom bags 200, flat bottom bags 210 and t-sacks 220 without digital printing on them

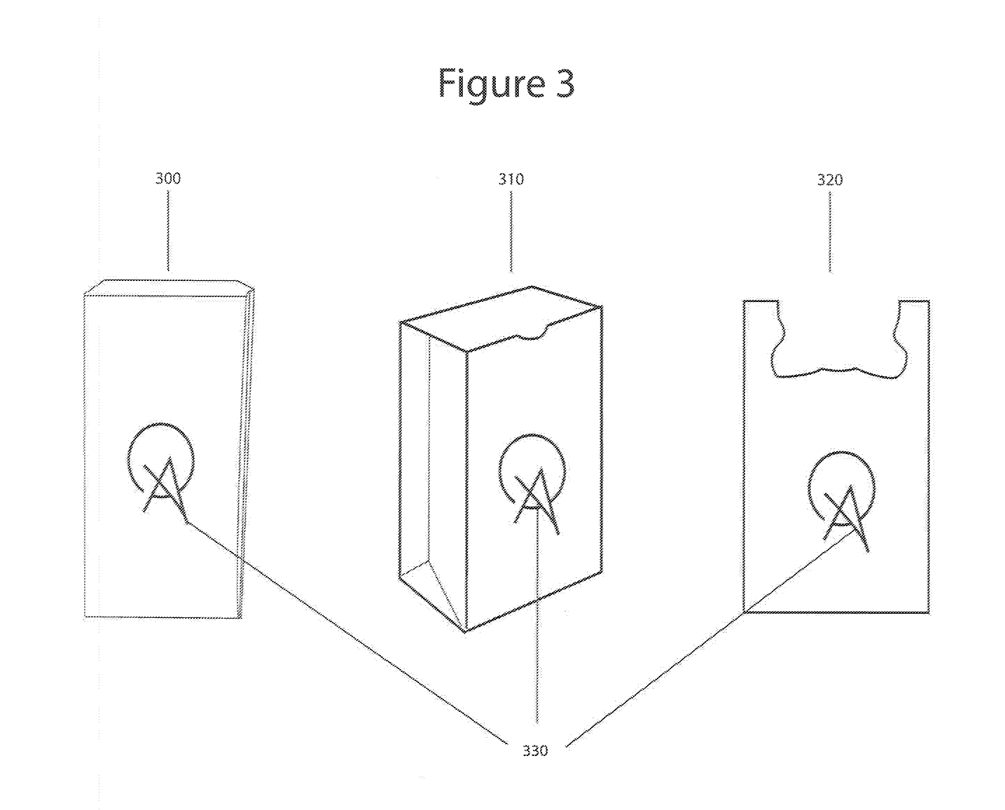

FIG. 3 shows pinch bottom bags 300, flat bottom bags 310 and t-sacks 220 with digital printing 330 on them. The digital printing 330 is from the deposit of ink or toner (not pictured) and adhered to the bag by fuser fluid, heat, UV curing or any combination.

1. Flexible and semi-rigid packaging materials having digital printing of graphics and/or text on the materials comprising:
said packaging materials comprised of paper;
said packaging material having a surface that has single or multiple color graphics and/or text printed on said surface of said packaging material;
said graphics or text comprising ink or toner deposited on said surface of said packaging material;
said ink or toner adhered to said surface of said packaging material by use of a fuser fluid, heat, UV curing or any combination.

2. The packaging materials of claim 1 wherein said packaging material comprises paper products, wherein said paper products comprise rolls of bags, bags, sheets of corrugate, corrugate, sheets of cardboard, cardboard and cartons,

3. Flexible and semi-rigid packaging materials having digital printing of graphics and/or text on the materials comprising:
said packaging materials comprised of polyethylene;
said packaging materials having a surface that has single or multiple color graphics and/or text printed on said surface of said packaging material;
said graphics or text comprising ink or toner deposited on said surfaces of said packaging material;
said ink or toner adhered to said surface of said packaging material by use of a fuser fluid, heat, UV curing or any combination.

4. The packaging materials of claim 3 wherein said packaging material comprise polyethylene products, wherein said polyethylene products comprise t-sacks, sheeting, tubing, covers such as furniture covers and dust covers, storage bags such as mattress bags and food pouches.

5. The packaging materials of claim 2 wherein said materials are digitally printed on before forming into paper products.

6. The packaging materials of claim 4 wherein said materials are digitally printed on before forming into polyethylene products.

7. The packaging materials of claim 2 wherein said materials are digitally printed on after they are formed into paper products.

8. The packaging materials of claim 4 wherein said materials are digitally printed on after they are formed into polyethylene products.

9. Pinch bottom bags and flat bottom bags having digital printing of graphics and/or text on the bags comprising:
said bags comprised of paper;
said bags having a surface that has single or multiple color graphics and/or text digitally printed on said surface of said bags;
said graphics or text comprising ink or toner deposited on said surface of said bags;
said ink or toner adhered to said surface of said bags by use of a fuser fluid, heat, UV curing or any combination.

10. Pinch bottom bags and flat bottom bags having digital printing of graphics and/or text on the bags comprising:
said bags comprised of polyethylene;
said bags having a surface that has single or multiple color graphics and/or text digitally printed on a surface of said bags;
said graphics or text comprising ink or toner deposited on said surface of said bags;
said ink or toner adhered to said surface of said bags by use of a fuser fluid, heat, UV curing or any combination.

11. The bags of claim 9 wherein said bags are digitally printed on before forming into paper pinch bottom or flat bottom bags.

12. The bags of claim 10 wherein said bags are digitally printed on before forming into polyethylene pinch bottom or flat bottom bags.

13. The bags of claim 9 wherein said bags are digitally printed on after they are formed into paper pinch bottom or flat bottom bags.

14. The bags of claim 10 wherein said bags are digitally printed on after they are formed into polyethylene pinch bottom or flat bottom bags.
